(19) United States
(12) Patent Application Publication
(10) Pub. No.: US 2026/0249484 A1
(43) Pub. Date: Aug. 27, 2026

(54) DEVICE FOR GRIPPING A MODULE OF ELECTROCHEMICAL CELLS

(71) Applicant: SAFT, Levallois-Perret (FR)

(72) Inventors: Eric PASQUIER, Saint-Benoît (FR); Yves LACAUGIRAUD, POITIERS (FR); Damien ROCHARD, Sèvres-Anxaumont (FR)

(73) Assignee: SAFT, Levallois-Perret (FR)

(21) Appl. No.: 18/856,134

(22) PCT Filed: Mar. 16, 2023
(86) PCT No.: PCT/EP2023/056798

§ 371 Date: Oct. 11, 2024

(30) Foreign Application Priority Data
Apr. 13, 2022 (FR) 2203410

(51) Int. Cl. B25J 15/00

(52) U.S. Cl. CPC B25J 15/0047

(57) ABSTRACT

A gripping device (1), comprising:
a rod (2) provided with a first abutment (3) and a second abutment (4),
a polymer sleeve (5) crossed by the rod and having a first end (6) and a second end (7), the first end (6) being in contact with the first abutment;
a first pressure piece (8) configured to exert a pressure on the second end (7) of the sleeve (5);
a spring (9) crossed by the rod and disposed between the first pressure piece (8) and the second abutment and
a means (10) for compressing the spring, an action on the means for compressing the spring causing, via the first pressure piece (8), a shrinkage in the length of the sleeve in the axial direction and an expansion of the sleeve in the radial direction.

### TECHNICAL FIELD OF THE INVENTION

The technical field of the invention is that of devices used for gripping a module of electrochemical cells. It also concerns the field of hoisting tools for lifting in a single operation a battery consisting of a plurality of modules of electrochemical cells.

### BACKGROUND OF THE INVENTION

A battery is constituted by the association and the electrical connection of several electrochemical cells, also called cells in the following. An electrical connection in series of several electrochemical cells makes it possible to add the voltages of these cells and to reach the desired operating voltage for the battery. An electrical connection in parallel of several cells makes it possible to add the capacities of the cells and to reach the desired operating capacity for the battery. The constitution of a battery may require having to resort to a large number of cells when the voltage or the capacity of a single element is low in comparison with the voltage and the capacity sought for the battery.

Forming the battery by assembling the cells one by one on a common support constitutes a long and tedious task. This is why modules consisting of the association of several cells already electrically connected to each other are generally manufactured in advance, and these modules are fixed on a common support which is the support of the battery. Each module can for example comprise 3, 4, 5 or 6 cells. It constitutes a unitary structure of fixed volume delivering predetermined voltage and quantity of energy which are functions of the electrical connection mode for the cells in the module.

The displacement of a module by an operator requires the use of a specific tool because the weight of the module can be high and it must be possible to lift it safely. It is necessary to have a gripping tool which ensures the hoisting of the module without risk of detachment of the latter.

Gripping tools exist. Some comprise two flat jaws that clamp two opposite faces of an object. Documents GB 0 011 863, GB 2 105 631, US 2007/0046048 and U.S. Pat. No. 4,968,077 can be mentioned. However, these tools do not allow seizing the module from the top. However, seizing the module from the top would be appropriate because the part located under the module is not accessible, given that the module rests on a support. Tools that allow lifting the module by seizing the top of the module are sought. One possibility for lifting a module from the top consists in taking advantage of a bore present on the upper face of the module. An additional constraint is that this bore may have a smooth wall, i.e. without a notch, a thread, a snap-in means or an attachment means. In this case, the gripping tool must be able to bear on this wall, even though the latter is smooth.

There are tools that bear on the smooth walls of a bore and exert pressure on the walls of this bore in a radial direction. A clamping sleeve can be mentioned. The sleeve is introduced into the bore and its diameter is increased using a screw. By increasing the diameter of the sleeve, the friction force between the sleeve and the surface of the bore is amplified until this force is sufficient to compensate for the weight of the module. This type of sleeve involves a screwing operation of each sleeve onto the bore, which lengthens the preparation time required to hoist the module.

There are also clamp-shaped tools. The jaws of the clamp act like claws that spread apart from each other and bear on diametrically opposite points of the bore. This solution is also not satisfactory because the jaws of the clamp scratch the wall of the bore, given the significant radial force applied on the walls of the module cavity.

A means for gripping a module is sought, which:
allows seizing the module from the top,
provides sufficient friction force to lift the module, even when the gripping means is put in contact with a smooth surface of the module,
does not damage the surface in contact with which it is placed,
does not require screwing, locking or snapping onto the module,
maintains good gripping quality of the module and compensates for any event that could harm this good gripping quality.

In addition, it is desirable for the operator to have a hoisting tool for lifting a battery resulting from the association of a large number of modules, for example 10 or 20 modules at a time.

### SUMMARY OF THE INVENTION

For this purpose, the invention proposes a gripping device comprising:
a rod provided with a first abutment and a second abutment,
a polymer sleeve crossed by the rod and having a first and a second end, the first end being in contact with the first abutment,
a first pressure piece configured to exert a pressure on the second end of the sleeve,
a spring crossed by the rod and disposed between the first pressure piece and the second abutment,
a means for compressing the spring, an action on the means for compressing the spring causing, via the first pressure piece, a shrinking of the length of the sleeve in the axial direction and an expansion of the sleeve in the radial direction,

The invention is based on the exploitation of the restoring force of a spring in the stressed state to maintain a compression applied to the two ends of a deformable polymer sleeve introduced into a cavity of the object to be lifted.

Under the effect of the applied compression, the length of the sleeve is reduced. The sleeve being incompressible, it expands radially. The radial expansion of the sleeve creates a friction force against the wall of the cavity of the object. The higher this friction force the greater the capacity of the device to lift heavy objects. The invention makes it possible, by varying the restoring force of the spring, to vary this friction force to adapt it to the mass of the object to be lifted. In addition, the restoring force of the pre-stressed spring makes it possible to maintain the same level of friction between the device and the object, by compensating for the possible fluctuations in the parameters that play a role in the quality of the holding of the object, such as the chemical composition of the sleeve, the aging state of the sleeve, the distance between the outer surface of the sleeve and the wall of the cavity of the object.

According to one embodiment, the means for compressing the spring comprises:
a second pressure piece crossed by the rod and located between the first pressure piece and the second abutment,
a means for allowing the displacement of the second pressure piece between the first pressure piece and the second abutment, for example a cam.

According to one embodiment, the spring is disposed between the second pressure piece and the second abutment and the means for allowing the displacement of the second pressure piece is configured to bring the second pressure piece closer to the second abutment, thus compressing the spring.

According to one embodiment, the spring is disposed between the first and the second pressure piece and the means for allowing the displacement of the second pressure piece is configured to bring the second pressure piece closer to the first pressure piece, thereby compressing the spring.

According to one embodiment, the rod is threaded, and
either the means for compressing the spring comprises a nut screwed onto the threaded rod and the second pressure piece is a ring, the rotation of the nut allowing a displacement of the ring along the threaded rod and an adjustment of the length of the spring.
or the means for compressing the spring is a ring tapped and screwed onto the threaded rod.

According to one embodiment, the polymer sleeve is made of silicone.

According to one embodiment, the at least one of the first or of the second pressure piece is a washer whose internal diameter is crossed by the rod.

According to one embodiment, the internal edge of the washer comprises a centering annulus for centering the position of the spring on the rod.

The invention also relates to a hoisting tool comprising a plurality of gripping devices as described above.

According to one embodiment, the means for compressing the springs of the plurality of the gripping devices comprises:
a second pressure piece crossed by the rod and located between the first pressure piece and the second abutment,
a means for allowing the displacement of the second pressure piece between the first pressure piece and the second abutment, for example a cam, and
the set of second abutments of the plurality of the gripping devices is fixed to an upper tray of the hoisting tool,
the set of first pressure pieces of the plurality of the gripping devices is fixed to a lower tray of the hoisting tool,
the set of second pressure pieces of the plurality of the gripping devices is fixed to an intermediate tray located between the upper tray and the lower tray.

According to one embodiment, the hoisting tool comprises one or more arms configured to drive in rotation one or more cams located between the lower tray and the intermediate tray, the rotation of said one or more cams allowing the displacement of the intermediate tray and the compression of the springs of the plurality of gripping devices.

According to one embodiment, the springs of the plurality of gripping devices are disposed between the upper tray and the intermediate tray and the rotation of said one or more cams causes the compression of the springs of the plurality of gripping devices between the upper tray and the intermediate tray.

The invention also relates to an assembly comprising:
the hoisting tool as described above, and
a plurality of modules of electrochemical cells, each module of electrochemical cells including at least one cavity, the cavity receiving one end of the rod of a gripping device.

According to one embodiment, the cavity has walls without a notch, a thread, a snap-in means or a means for attaching the rod of the gripping device in the cavity.

According to one embodiment, the cavity opens out onto an upper wall of the module.

According to one embodiment, the upper tray is provided with means for hooking slings to hoist the assembly.

### BRIEF DESCRIPTION OF THE FIGURES

Embodiments of the invention are described below in more detail with reference to the following figures:

FIG. 1 is a sectional view of the gripping device according to a first embodiment of the invention. The left diagram shows the pressure device for a spring in an uncompressed state. The right diagram shows the pressure device for a spring in a compressed state.

FIG. 2 is a sectional view of the gripping device according to a second embodiment of the invention. The left diagram shows the pressure device for a spring in an uncompressed state. The right diagram shows the pressure device for a spring in a compressed state.

FIG. 3 is a sectional view of the gripping device according to a third embodiment of the invention.

FIG. 4 is a sectional view of the first pressure piece, which has a centering annulus.

FIG. 5 is a perspective view of a hoisting tool in which the arms are in the open position and the springs of the gripping devices are not compressed.

FIG. 6 is a perspective view of a hoisting tool in which the arms are in the closed position, this having the effect of compressing the springs of the gripping devices.

FIG. 7 is a perspective view of a battery consisting in assembling several modules of electrochemical cells. This view shows in particular the upper surface of the modules. Each upper surface includes a cavity for the introduction of a gripping device.

FIG. 8 is a perspective view of a hoisting tool after the gripping devices have been placed in the cavities located on the upper surface of the modules and the springs of the gripping devices have been compressed.

### DESCRIPTION OF EMBODIMENTS OF THE INVENTION

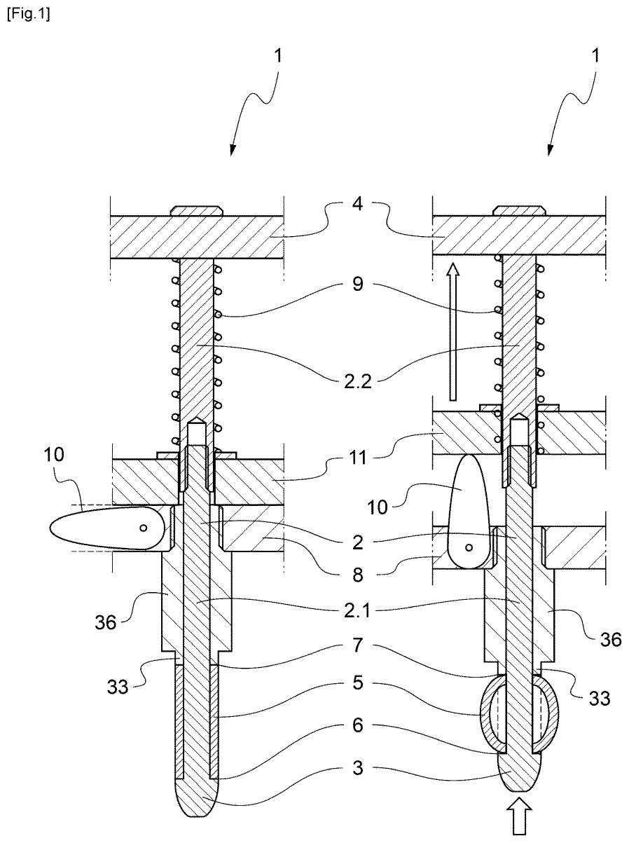

The gripping device according to the invention will be described below with reference to FIGS. 1 to 4. The device (1) is intended to be inserted into a cavity (34) located on an upper face (32) of the object (31) to be lifted. The device is advantageously used to lift a module of electrochemical cells (31), for example of the lithium-ion type, but it is understood that it can be used to lift any object, as long as the shape and dimensions of the sleeve correspond to those of the cavity of this object.

The cavity of the module can be located on a component serving as a common support for the electrochemical cells (31). This can be a bore (34) made through the cross section of a beam serving as a support for the cells. The cross section of the rod of the gripping device and the cross section of the cavity are preferably circular. The wall of the cavity is preferably smooth. The term “smooth” means a wall without notches, threads, snap-in means, ridges or means for attaching the rod of the gripping device in the cavity.

The rod (2) of the device may consist of a single piece with or without portions of different diameters. It may also be constituted by the interlocking of two pieces (2.1, 2.2) or more pieces, with identical or different diameters. In one embodiment, the rod consists of the interlocking of two pieces (2.1, 2.2) of different diameters. The rod comprises, at one of its ends, a first abutment (3) and, at the opposite end, a second abutment (4). The end of the device comprising the first abutment is introduced first into the cavity (34) of the object to be lifted. The first abutment may consist of a boss on the end of the rod. Preferably, the boss has an oblong shape to facilitate the insertion of the device into the cavity.

One of the ends (6) of the sleeve (5) bears on this boss (3). The sleeve is preferably cylindrical. The external diameter of the sleeve is adapted to the diameter of the cavity and is such that it allows the sleeve to enter the cavity of the object before compression of the sleeve in its longitudinal direction. The external diameter of the sleeve is slightly smaller than the diameter of the cavity. It must not be too small compared to the diameter of the cavity at the risk of creating an insufficient friction force with the cavity of the object to be lifted. It must not be too close to the diameter of the cavity at the risk of causing resistance to the introduction of the tool into the cavity. The diameter of the sleeve is preferably equal to the diameter of the boss in its most flared part.

A first pressure piece (8) is placed on the end of the sleeve (7) opposite to the one (6) in contact with the boss (3). It is movable on the rod (2.1). Its displacement towards the first abutment (3) makes it possible to apply a compressive force to the sleeve along its longitudinal axis because the latter is sandwiched between the first abutment (3) and the first pressure piece (8). The compression exerted by the first pressure piece (8) causes a reduction in the length of the sleeve (7) and its expansion in the radial direction in the cavity of the object. The expansion of the sleeve in the radial direction creates a friction force radially directed in the cavity. The friction force between the sleeve and the cavity is greater than the weight of the object, which makes it possible to lift the object and maintain it in its lifted position.

The sleeve (5) is preferably made of an elastomeric material thus having a certain elasticity, for example silicone, and a high friction force with the material of the cavity (34) against which it is put in contact. The length of the sleeve (5) is determined by those skilled in the art depending on the nature of the material of the sleeve and on the mass to be lifted. An increase in the length of the sleeve makes it possible to increase the friction forces with the cavity and to lift heavier objects. As an order of magnitude, a silicone sleeve with a length of 20 to 30 mm makes it possible to lift without irreversible sliding, therefore in a linear area linking effort and displacement, a mass of up to 3 kg by taking into account a safety factor of 3, and a safety factor of 5 in the case of irreversible sliding, therefore in a non-linear area linking effort and displacement.

The spring used (9) is preferably helical. Its coils surround a portion (2.2) of the external surface of the rod. An operator applies a compressive force to the spring. In reaction to this compressive force, the spring exerts a restoring force which is applied in the longitudinal direction of the sleeve (5). This restoring force is equal to the product of the spring stiffness constant by the difference between the length of the spring in the compressed state and its empty length, i.e. in the uncompressed state. This restoring force is exploited to compress the sleeve, as explained above.

The presence of the spring (9) makes it possible to maintain the axial force on the sleeve (5) despite any change likely to occur in the friction area between the object to be lifted and the tool. For example, aging of the sleeve material could lead to its hardening and less pronounced radial expansion in the cavity of the object, therefore a less secure hold between the sleeve and the cavity and a detachment of the object. A variability in the bore manufacturing method could lead to a variation in the diameter of the bore, also leading to a less secure hold between the sleeve and the cavity. Finally, the mass of the object to be lifted could also present a certain variability. The spring (9) compensates for any relaxation or displacement of the present pieces by continuing to apply an effort in the direction of the longitudinal axis of the sleeve (5) which is disposed between the first abutment (3) and the first pressure piece (8).

The mere fact of moving the sleeve between the first abutment (3) and the first pressure piece (8) does not guarantee sufficient hold between the sleeve and the cavity to maintain the object in the hoisted position. The invention makes it possible to maintain a compressive force on the sleeve thanks to the spring.

The means used by the user to compress the spring comprises:
a second pressure piece (11) crossed by the rod and located between the first pressure piece (8) and the second abutment (4),
a means (10) for allowing the displacement of the second pressure piece (11) between the first pressure piece (8) and the second abutment (4).

The spring (9) can exert its restoring force indirectly on the first pressure piece (8). In this case, the spring is placed between the second abutment (4) and the second pressure piece (11). A means allows bringing the second pressure piece (11) closer to the second abutment (4) and the compression of the spring (9). This means (10) can be disposed between the first pressure piece (8) and the second pressure piece (11). It maintains a predetermined distance between the first pressure piece and the second pressure piece. This distance is proportional to the compressive force that the operator wishes to apply to the spring, i.e. the preload of the spring. The spring restoring force is transmitted to the first pressure piece (8) via the means (10) for moving the second pressure piece (11). The first pressure piece then communicates the spring restoring force to the sleeve (5). Such an embodiment is represented in FIG. 1.

The spring (9) can exert its restoring force directly on the first pressure piece (8). In this case, the spring is placed between the first pressure piece (8) and the second pressure piece (11). A means (10) allows bringing the second pressure piece (11) closer to the first pressure piece (8) and compressing the spring. This means can be disposed between the second pressure piece (11) and the second abutment (4). It maintains a predetermined distance between the second pressure piece (11) and the second abutment (4). This distance is proportional to the compressive force that the operator wishes to apply to the spring. Unlike the embodiment of FIG. 1, the spring restoring force is applied directly to the first pressure piece which then communicates it to the sleeve.

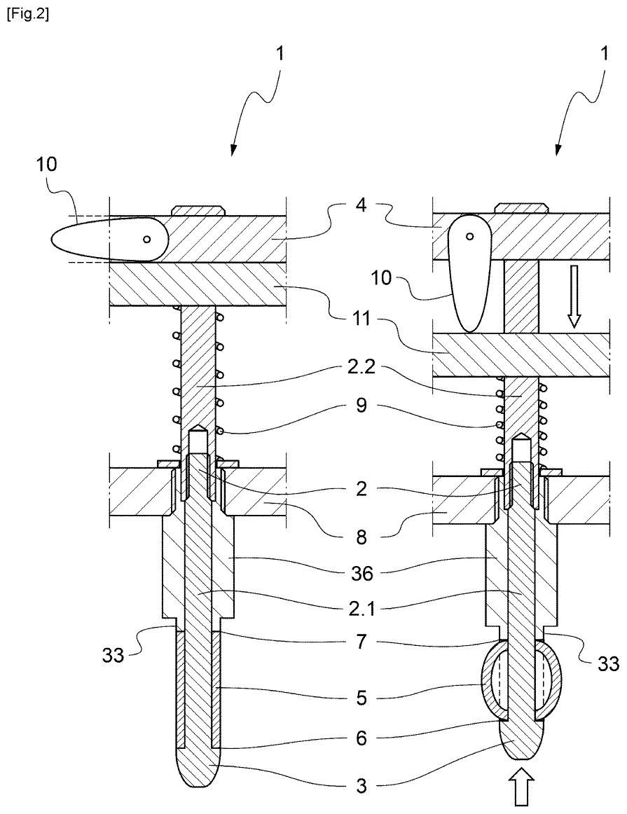

Such an embodiment is represented in FIG. 2.

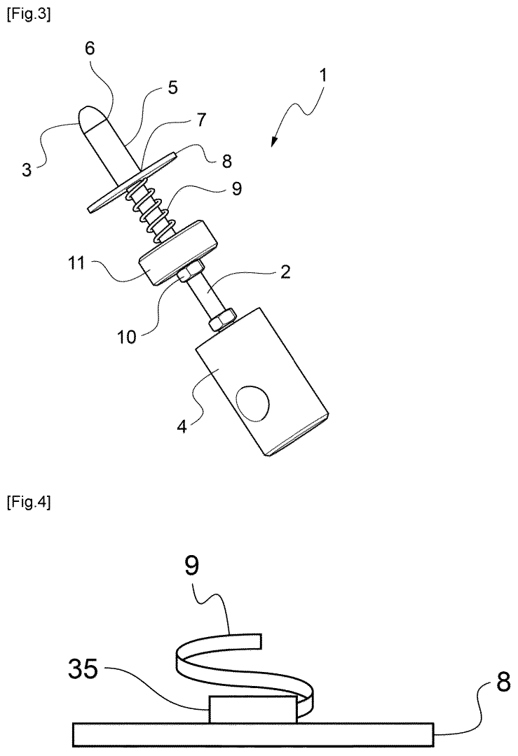

The means (10) for moving the second pressure piece may be a cam. The means for moving the second pressure piece may also be a nut (10) screwed onto a thread made on the external surface of the rod (2), as illustrated in FIG. 3. The rotation of the nut allows its displacement on the rod. The displacement of the nut varies the position of the second pressure piece (11) on the threaded rod, which modifies the compression state of the spring. The second pressure piece (11) may be a ring. The ring can also include a tapping allowing its displacement on the rod and a blocking of its position on the screw. The tapped ring then combines the function of a second pressure piece and a means for moving the second pressure piece.

The first pressure piece (8) may be a washer or a plate including an opening, for example of a circular shape. The rod (2) is inserted through the internal diameter of the washer or the opening of the plate and can slide through the opening. The surface of the washer or of the plate extends perpendicular to the rod and receives the restoring force of the spring which is applied along the direction of the rod. The edges of the opening may include a shoulder (35), also called centering annulus, intended to guide the restoring force of the spring on the rod, as represented in FIG. 4. The centering annulus makes it possible to reduce the risk of buckling of the spring, to maintain the plate or the washer perpendicular to the rod, particularly when the spring is highly compressed, and therefore improves the quality of the contact between the sleeve and the wall of the cavity. The centering annulus (35) is placed in contact with the inside of the first coil of the spring (9). The centering annulus may not be necessary if the diameter of the rod at the location (2.2) where the spring is disposed is large enough to serve as a centering device itself and prevent buckling of the spring. The flat surface of the plate or of the washer may be in direct contact with the end of the sleeve.

Preferably, a guide (36) is fixed on the opening of the plate or of the washer (8). It extends in the direction of the length of the rod. Its purposes are to allow guidance of the rod (2) in the plate (8) and clearance (and bearing) between the hoisting tool and the battery to be lifted. It will be up to each person to choose the length that suits them. A first particularity of the guide is that its end length (33) is sufficient to ensure that the sleeve (5) is completely inserted into the cavity and is located at a minimum distance from the mouth of the cavity before compression of the sleeve. Thus, in the event of a slight sliding of the sleeve out of the cavity, after it has expanded, it does not come out of the cavity. Even partial withdrawal of the sleeve (5) out of the cavity would result in a loss of friction between the sleeve and the wall of the cavity (34). A sufficient length of the end (33) of the guide ensures that no compression of the sleeve is lost by withdrawal of part of the volume of the sleeve out of the cavity. A second advantage associated with the sufficient length of the end (33) of the guide is that the appearance of a bulge is avoided when placing the tool in the event that the end of the sleeve is too close to the mouth of the cavity. A second particularity of the guide is that the end (33) of the guide in contact with the sleeve preferably has a shape and diameter identical to the shape and diameter of the sleeve (5). If the end (33) of the guide (36) has a diameter greater than that of the sleeve (5), there is a risk that the guide will abut on the mouth of the cavity (34). Conversely, if the end (33) of the guide (36) has a diameter smaller than that of the sleeve (5), there is a risk that part of the upper part of the sleeve will escape from the cavity and form a bulge out of the cavity.

The gripping device can be disengaged from the object by releasing the compression applied on the spring. As the sleeve is then no longer compressed axially, it resumes its initial length and diameter. The retraction of the sleeve in the radial direction eliminates the friction forces with the cavity.

The association of several gripping devices (1) makes it possible to constitute a hoisting tool (20). The hoisting tool can be used to simultaneously lift a plurality of modules of electrochemical cells (31) intended to be assembled into a battery. The hoisting tool includes a frame. This frame comprises at least three trays (21, 22, 23) disposed in parallel: a lower tray (22), an upper tray (21) and an intermediate tray (23) disposed between the lower tray and the upper tray. The lower tray (22) representing the first pressure piece (8) according to FIG. 1 is pierced with a plurality of holes. The guide (36) of the gripping device is fixed on each hole. The intermediate tray (23) representing the second pressure piece (11) according to FIG. 1, is pierced with a plurality of holes located in alignment with the holes of the lower tray. The upper tray (21) is pierced with a plurality of holes located in alignment with the holes of the intermediate and lower trays. Each of the holes in the tray (21) constitutes the second abutment (4) of the gripping device fixed thereto.

The intermediate tray (23) is vertically movable. It can move upwards towards the upper tray (21) and compress the springs, according to the operating mode illustrated in FIG. 1. It can move downwards towards the lower tray (22) and compress the springs, according to the operating mode illustrated in FIG. 2. In both operating modes, a displacement of the intermediate tray causes the compression of the set of springs of the gripping devices and a radial expansion of all the sleeves in the cavity of the modules, which allows the gripping of all the modules in a single operation.

The displacement of the intermediate tray can be actuated by the rotation of a cam disposed between the lower tray (22) and the intermediate tray (23) for the embodiment illustrated in FIG. 1 or between the intermediate tray (23) and the upper tray (21) for the embodiment illustrated in FIG. 2. The cam can be secured to an arm (24). A rotational movement of the arm (or arms according to the embodiment) causes a rotation of the cam (10) which communicates to the intermediate tray (23) a vertical displacement upwards or downwards (parallel translation of (23) relative to (22)). This can be done over a few centimeters. The height of vertical displacement of the tray corresponds to the length by which the spring shrinks. It is therefore possible to vary the restoring force of the spring to adapt it to the mass of the load to be lifted by varying the height of displacement of the intermediate tray and therefore the profile of the cam.

In order to distribute the force to overcome the resistance of the springs, two cams are preferably disposed at two opposite ends of the frame.

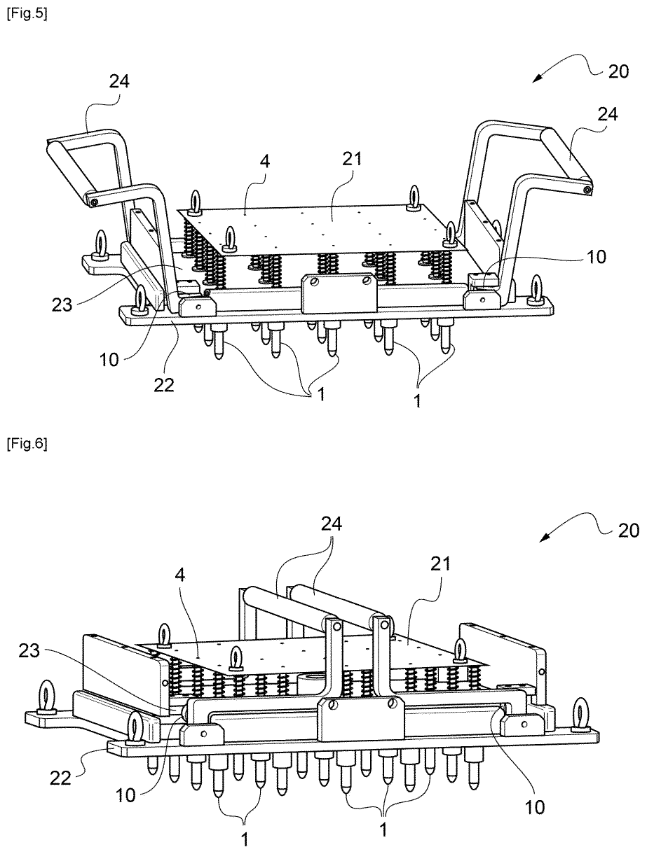

The movement of the two arms can be a rotational movement of about 90° from a nearly vertical orientation of the arms to a nearly horizontal orientation. FIG. 5 shows the hoisting tool when the arms (24) are in the open position and the springs of the gripping devices are not compressed. The arms are made to perform a rotational movement of about 90° to be brought into the closed position. FIG. 6 shows the hoisting tool when the arms are in the closed position and the springs of the gripping devices are compressed. During the rotational movement of the arms, the cam associated with each arm also performs a rotational movement of 90°. The rotational movement of the cam communicates a vertical translational movement of the intermediate tray upwards or downwards. The intermediate tray moves by a distance corresponding to the shortening distance of each of the springs of the gripping devices.

The upper tray (21) can include at its four corners points of fixing a means for attaching the hoisting tool to a hoisting apparatus such as a crane, a winch or a forklift. This means for attaching the hoisting tool may be slings (25). Once the hoisting tool is locked onto the battery by compression of the springs, the hoisting tool can be attached to the hoisting apparatus and the assembly constituted by the hoisting tool and the battery can be hoisted.

### Description of the Battery

A battery is constituted by the assembly and the electrical connection of several modules of electrochemical cells. The electrochemical cells are secured within a single module using one or more flanges. A flange is constituted by a plate comprising on its largest surface a plurality of recesses intended to interlock with the bottom of the container of the electrochemical cells and/or with the cover of the electrochemical cells. Each recess matches the shape of the cross-section of the container or of the cover of the electrochemical cells. In addition to the function of assembling the cells within a module, the flange makes it possible to wedge the electrochemical cells in order to prevent them from being subjected to the harmful effects of the vibrations. The flange is generally made of an electrically insulating material, preferably a plastic material. It is generally obtained by molding a plastic material. For a better holding of the cells, two flanges are preferably used, one is interlocked onto the covers of the cells of the module. The second one is interlocked onto the bottoms of the cells.

The upper surface of the modules has a cavity. This cavity can be a bore machined in the longitudinal direction of the beam. This beam serves as a common support for the electrochemical cells of the module. It is preferably of circular section.

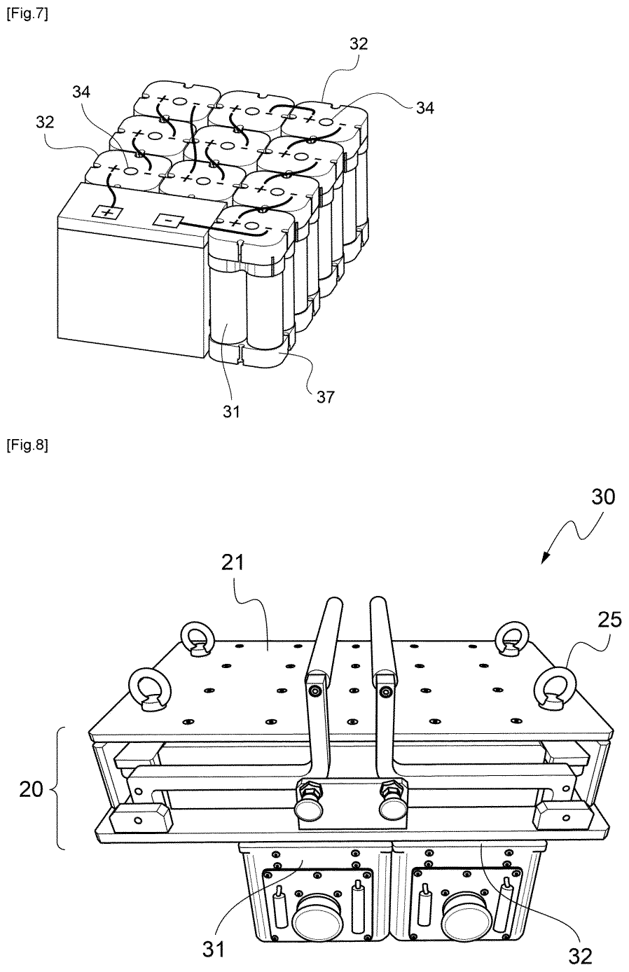

FIG. 7 is a perspective view of a battery constituted by the assembly of ten modules of electrochemical cells (31). Each module is constituted by the assembly and the electrical connection of four cells. The cells are maintained by an upper flange (32) and a lower flange (37). The upper surface of the modules is constituted by the upper flange. It shows in particular the upper surface (32) of the modules. The presence of a cavity (34) on the upper surface (32) of each module is noted. This cavity is used for the introduction of a gripping device according to the invention.

To lift the battery, the hoisting tool is placed above the battery. The end of the rod of the gripping tools is positioned at the vertical of the cavities. The hoisting tool is lowered to introduce the end of the rods into the cavities. The arms of the hoisting tool are actuated to move the intermediate tray. The latter moves either in an upward direction in the case of the embodiment of FIG. 1 or in a downward direction in the case of the embodiment of FIG. 2. The rotational movement of the arms causes a displacement of the intermediate tray by a distance corresponding to the desired shortening distance of each of the springs of the gripping devices, as explained above. FIG. 8 is a perspective view of a hoisting tool after the gripping devices have been placed in the cavities located on the upper surface of the modules, the arms have been closed and the springs of the gripping devices have been compressed.

1. A gripping device comprising:
a rod provided with a first abutment and a second abutment,
a polymer sleeve crossed by the rod and having a first and a second end the first end being in contact with the first abutment,
a first pressure piece configured to exert a pressure on the second end of the sleeve,
a spring crossed by the rod and disposed between the first pressure piece and the second abutment,
a means for compressing the spring, an action on the means for compressing the spring causing, via the first pressure piece, a shrinking of the length of the sleeve in the axial direction and an expansion of the sleeve in the radial direction.

2. The gripping device according to claim 1, wherein the means for compressing the spring comprises:
a second pressure piece crossed by the rod and located between the first pressure piece and the second abutment,
a means for allowing the displacement of the second pressure piece between the first pressure piece and the second abutment.

3. The gripping device according to claim 2, wherein the spring is disposed between the second pressure piece and the second abutment and the means for allowing the displacement of the second pressure piece is configured to bring the second pressure piece closer to the second abutment thereby compressing the spring.

4. The gripping device according to claim 2, wherein the spring is disposed between the first and the second pressure piece and the means for allowing the displacement of the second pressure piece is configured to bring the second pressure piece closer to the first pressure piece thereby compressing the spring.

5. The gripping device according to claim 4, wherein:
the rod is threaded, and
either the means for compressing the spring comprises a nut screwed onto the threaded rod and the second pressure piece is a ring, the rotation of the nut allowing a displacement of the ring along the threaded rod and an adjustment of the length of the spring,
or the means for compressing the spring is a ring tapped and screwed onto the threaded rod.

6. The gripping device according to claim 1, wherein the polymer sleeve is made of silicone.

7. The gripping device according to claim 1, wherein the at least one of the first or of the second pressure piece is a washer whose internal diameter is crossed by the rod.

8. The gripping device according to claim 7, wherein the internal edge of the washer comprises a centering annulus for centering the position of the spring on the rod.

9. A hoisting tool comprising a plurality of gripping devices according to claim 1.

10. The hoisting tool according to claim 9, wherein the means for compressing the springs of the plurality of the gripping devices comprises a second pressure piece crossed by the rod and located between the first pressure piece and the second abutment; and means for allowing the displacement of the second pressure piece between the first pressure piece and the second abutment, and
the set of second abutments of the plurality of the gripping devices is fixed to an upper tray of the hoisting tool,
the set of first pressure pieces of the plurality of the gripping devices is fixed to a lower tray of the hoisting tool,
the set of second pressure pieces of the plurality of the gripping devices is fixed to an intermediate tray located between the upper tray and the lower tray.

11. The hoisting tool according to claim 10, comprising one or more arms configured to drive in rotation one or more cams located between the lower tray and the intermediate tray, the rotation of said one or more cams allowing the displacement of the intermediate tray and the compression of the springs of the plurality of gripping devices.

12. The hoisting tool according to claim 11, wherein the springs of the plurality of gripping devices are disposed between the upper tray and the intermediate tray and the rotation of said one or more cams causes the compression of the springs of the plurality of gripping devices between the upper tray and the intermediate tray.

13. An assembly comprising:
the hoisting tool according to claim 9, and
a plurality of modules of electrochemical cells, each module of electrochemical cells including at least one cavity, the cavity receiving one end of the rod of a gripping device.

14. The assembly according to claim 13, wherein the cavity has walls without a notch, a thread, a snap-in means or a means for attaching the rod of the gripping device in the cavity.

15. The assembly according to claim 14, wherein the cavity opens out onto an upper wall of the module.

16. The assembly according to claim 13, wherein the upper tray is provided with means for attaching slings to hoist the assembly.
